(19) United States
(12) Patent Application Publication
(10) Pub. No.: US 2015/0147500 A1
(43) Pub. Date: May 28, 2015

(54) HEAT SHRINKABLE TUBE

(71) Applicant: TYCO ELECTRONICS CORPORATION, Berwyn, PA (US)

(72) Inventor: Lester T. TOY, Fremont, CA (US)

(73) Assignee: TYCO ELECTRONICS CORPORATION, Berwyn, PA (US)

(21) Appl. No.: 14/088,960

(22) Filed: Nov. 25, 2013

(51) Int. Cl. C08L 67/02

(52) U.S. Cl. CPC C08L 67/02; C08L 2205/025
USPC 428/35.1

(57) ABSTRACT

A heat shrinkable tube and system including a heat-recovered heat shrinkable tube are disclosed. The heat shrinkable tube includes an extrusion and expansion of a blend, the blend including a first polyolefin terephthalate copolymer and a second polyolefin terephthalate copolymer, the second component having a different composition from the first component. The extrusion and expansion are arranged as the heat shrinkable tube. The blend can have a glass transition temperature at least 85° C. and/or the blend can be irradiated to a higher viscosity.

### FIELD

The present invention is directed to heat shrinkable tubes. More particularly, the present invention is directed to heat shrinkable tubes having one or more polyolefin terephthalate copolymers.

### BACKGROUND OF THE INVENTION

Heat shrinkable tubing having polyethylene terephthalate (“PET”) is known. Such tubes can be formed into caps by the process of spiral winding strips of heat-shrink polyester film coated with an adhesive into a tube form and heat sealing one end to make caps. Since the caps are not transparent, it is difficult or impossible to perform adequate visual inspection of an electrical connection after installation using such PET heat shrinkable tubes.

The process of forming such tubes into a spiral wound cap has about 25% to about 50% diameter recovery and about 25% to about 50% high longitudinal shrinkage. As a result, several different sizes of the spiral wound caps are required to cover the wide range of cables. Polyethylene terephthalate (PET) is capable of being used as heat shrinkable tubing, for example, by being extruded and then expanded as a tube. The diameter recovery of known PET tubing is low, for example, about 70% diameter recovery, but the longitudinal shrinkage is also high at about 40%. As a result, several different diameters of tubing are required to cover a range of cables. Also, PET heat shrinkable tubing must be extruded at high processing temperatures (such as, above 265° C.), which results in degradation of the polymers.

Heat shrinkable tubing that does not suffer from one or more of the above drawbacks would be desirable in the art.

### BRIEF DESCRIPTION OF THE INVENTION

In an embodiment, a heat shrinkable tube includes an extrusion of a blend, the blend including a first polyolefin terephthalate copolymer and a second polyolefin terephthalate copolymer, the second component having a different composition from the first component. The extrusion is arranged as the heat shrinkable tube.

In another embodiment, a heat shrinkable tube includes an extrusion of a blend, the blend including a polyolefin terephthalate copolymer. The extrusion is arranged as the heat shrinkable tube. The blend has a glass transition temperature of at least 85° C.

In another embodiment, a heat shrinkable tube includes a heat shrinkable tube includes an extrusion of a blend, the blend comprising polyolefin terephthalate copolymer. The extrusion is irradiated and expanded to form the heat shrinkable tube.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a perspective view of a heat shrinkable tube, according to an embodiment of the disclosure.

FIG. 2 is a perspective view of a system including a heat-recovered heat shrinkable tube formed from a heat shrinkable tube, according to an embodiment of the disclosure.

FIG. 3 is a perspective view of a heat shrinkable tube having a cap, according to an embodiment of the disclosure.

FIG. 4 is a perspective view of a system including a heat-recovered heat shrinkable tube having a cap formed from a heat shrinkable tube, according to an embodiment of the disclosure.

Wherever possible, the same reference numbers will be used throughout the drawings to represent the same parts.

### DETAILED DESCRIPTION OF THE INVENTION

Provided is a heat shrinkable tube. Embodiments of the present disclosure, in comparison to similar concepts failing to include one or more of the features disclosed herein, are transparent or substantially transparent, are translucent or substantially translucent, are capable of stability through greater expansion in comparison to polyethylene terephthalate, have low longitudinal shrinkage (for example, 12%, 0% to 25%, 0% to 10%), have high diameter shrinkage (for example, 100% or 200% recovery), are capable of production with process stability, or a combination thereof

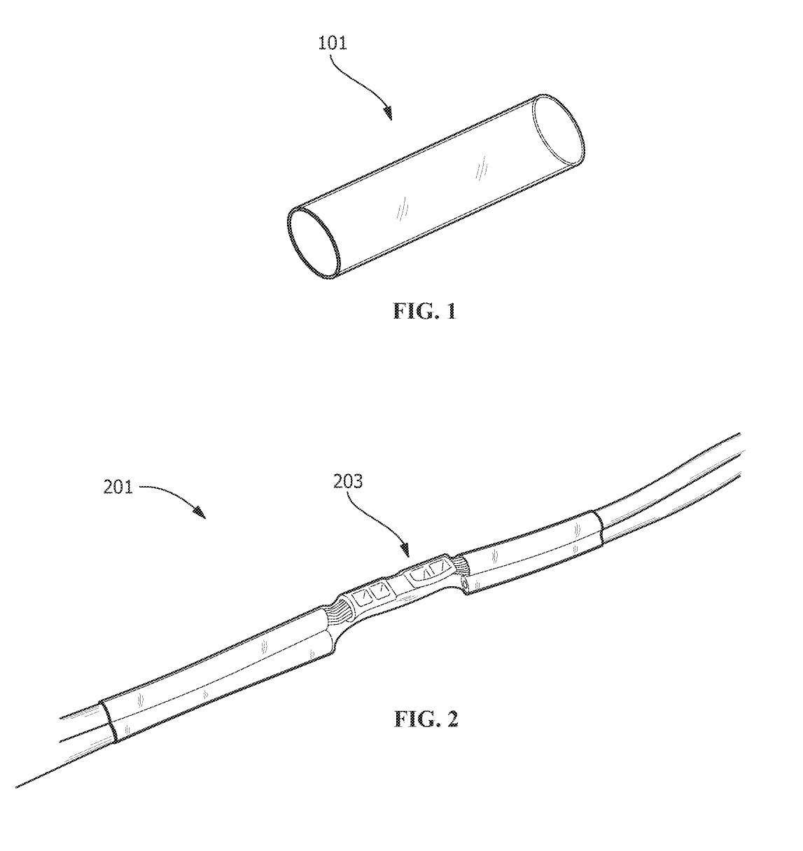

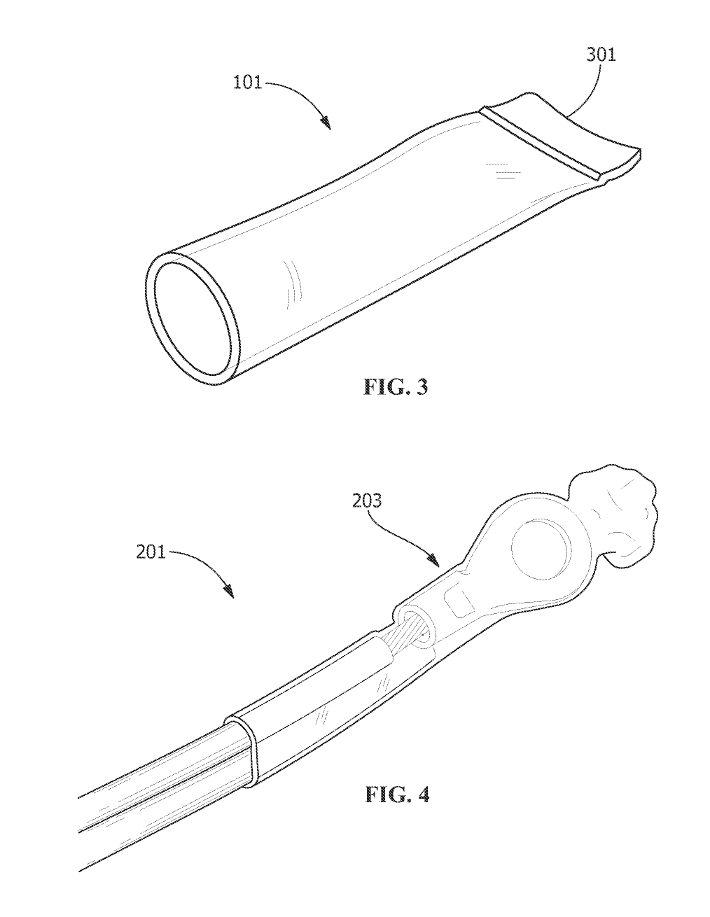

Referring to FIGS. 1 and 3, according to the disclosure, a heat shrinkable tube 101 is formed by a blend having one or more polyolefin terephthalate copolymers extruded as at least a portion of the heat shrinkable tube 101, such as, polyethylene terephthalate copolymers. As shown in FIG. 1, in one embodiment, the heat shrinkable tube 101 is devoid of a cap. As shown in FIG. 3, in one embodiment, the heat shrinkable tube 101 includes a cap 301 enclosing an end of the heat shrinkable tube 101. The polyolefin terephthalate copolymer(s) is/are or include(s) poly(cyclohexylene dimethylene terephthalate) glycol (“PCTG”), poly(cyclohexylene dimethylene terephthalate) acid (“PCTA”), poly(ethylene terephthalate) glycol (“PETG”), terephthalic acid (“TPA”) with tetramethyl-cyclobutanediol (“TMCD”) or another acid group and ethylene glycol (“EG”) or another diol, any other suitable copolymer of a polyolefin terephthalate, or a combination thereof. The heat shrinkable tube 101 is devoid of the PET or includes the PET being blended with the polyolefin terephthalate copolymer(s). For example, in one embodiment, the heat shrinkable tube 101 includes the polyolefin terephthalate copolymer(s) at a concentration, by weight, of at least 20%, at least 60%, at least 85%, between 50% and 100%, between 50% and 97%, between 60% and 100%, between 60% and 97%, between 97% and 100%, 100%, 97%, 90%, or any suitable combination, sub-combination, range, or sub-range therein (with incidental impurities).

The heat shrinkable tube 101 has any suitable diameter. In one embodiment, the expanded diameter is at least 0.1 inches, at least 0.2 inches, at least 0.5 inches, at least 1 inch, between 0.1 inches and 0.5 inches, between 0.5 inches and 3 inches, between 1 inch and 2 inches, between 0.5 inches and 3 inches, between 0.2 inches and 0.4 inches, between 0.25 inches and 0.35 inches, between 0.3 inches and 0.35 inches, or any suitable combination, sub-combination, range, or sub-range therein. The heat shrinkable tube 101 has an expansion and/or recovery ratio that is greater than PET. In one embodiment, the expansion and/or recovery ratio is greater than 1.5, greater than 2, between 1.5 and 4, between 2 and 3, between 2 and 2.5, or any suitable combination, sub-combination, range, or sub-range therein. The expansion and/or recovery ratio is based upon diameter expansion and recovery of the heat shrinkable tube 101, for example, over 3 minutes at 100° C.

In one embodiment, the longitudinal shrinkage of the heat shrinkable tube 101 is less than 50%, between 0% and 25%, or between 0% and 10%, for example, at 100° C. temperature for 3 minutes.

In one embodiment, the suitability of the polyolefin terephthalate copolymer(s) is/are, at least in part, based upon a heat of fusion of the polyolefin terephthalate copolymer, corresponding with a low crystallinity. Suitable heats of fusion (for the heat shrinkable tube 101 and/or a heat-recovered heat shrinkable tube 203) are less than 40 J/g, less than 1 J/g, zero J/g, between 20 J/g and 40 J/g, between 20 J/g and 30 J/g, between 30 J/g and 40 J/g, between 10 J/g and 40 J/g, between 10 J/g and 20 J/g, between 1 J/g and 10 J/g, between 1 J/g and 20 J/g, between zero and 10 J/g, or any suitable combination, sub-combination, range, or sub-range therein.

In one embodiment, the suitability of the polyolefin terephthalate copolymer(s) is/are, at least in part, based upon a melting temperature peak of the polyolefin terephthalate copolymer. Suitable melting temperature peaks include, but are not limited to, less than 250° C., less than 200° C., less than 150° C., less than 100° C., between 90° C. and 250° C., between 200° C. and 250° C., or any suitable combination, sub-combination, range, or sub-range therein.

In one embodiment, the suitability of the polyolefin terephthalate copolymer(s) is/are, at least in part, based upon an inherent viscosity of the polyolefin terephthalate copolymer. Suitable inherent viscosities include, but are not limited to, at least 0.63 dL/g, at least 0.7 dL/g, at least 0.65 dL/g, at least 0.75 dL/g, between 0.63 dL/g and 0.9 dL/g, between 0.65 dL/g and 0.85 dL/g, between 0.7 dL/g and 0.8 dL/g, between 0.75 dL/g and 0.85 dL/g, or any suitable combination, sub-combination, range, or sub-range therein. In one embodiment, the inherent viscosity is balanced with extrudability and expandability.

In one embodiment, the suitability of the polyolefin terephthalate copolymer(s) is/are, at least in part, based upon a capability of being stable through expansion of at least 100%, by diameter. Other suitable expansion capabilities include, but are not limited to, being capable of being stable through expansion of at least 200%, being capable of being stable through expansion between 100% and 300%, or any suitable combination, sub-combination, range, or sub-range therein. As used herein, the term “stable” refers to allowing continuous expansion without collapsing or bursting.

In one embodiment, the suitability of the polyolefin terephthalate copolymer(s) is/are, at least in part, based upon having a tensile strength between 6600 psi and 6700 psi, a secant modulus of between 200,000 psi and 220,000 psi, a volume resistivity of between 1.5 E+16 ohm-cm and 1.7 E+16 ohm-cm, or a combination thereof

The polyolefin terephthalate copolymer(s) is/are modified by irradiation or not modified by irradiation. In one embodiment, an epoxy in the blend increases the viscosity. Additionally or alternatively, in one embodiment, the irradiation modifies the modulus and/or viscosity of the polyolefin terephthalate copolymer, for example, increasing the cross-link density. The irradiation is by any suitable amount from 2 to 60 Mrads, for example, including, but not limited to, at least 10 Mrads, 10 Mrads, at least 20 Mrads, 20 Mrads, between 5 Mrads and 25 Mrads, between 10 Mrads and 20 Mrads, or any suitable combination, sub-combination, range, or sub-range therein. In one embodiment, the increase in modulus is to greater than 10 psi with 20 Mrads at 150° C., greater than 14 psi with 20 Mrads at 150° C., between 10 psi and 20 psi with 20 Mrads at 150° C., between 13 psi and 17 psi with 20 Mrads at 150° C., between 14 psi and 16 psi with 20 Mrads at 150° C., or any suitable combination, sub-combination, range, or sub-range therein.

In one embodiment, the polyolefin terephthalate copolymer(s) is/are blended with a radiation promoter or crosslinker, such as triallyl cyanurate, triallyl isocyanurate, multifunctional acrylates or methacrylates and polymers containing epoxide or anhydride functional groups at any suitable concentration and exposed to ionizing radiation or not exposed to ionizing radiation. Suitable concentrations include, but are not limited to, the polyolefin terephthalate copolymer being at a concentration, by weight, of at least 20%, at least 50%, between 70% and 98%, or any suitable combination, sub-combination, range, or sub-range therein. Additionally or alternatively, suitable concentrations include, but are not limited to, the cross-linking agent being at a concentration from 0.5 to 20%, by weight, of between 1% and 5%, between 2% and 4%, between 2.5% and 3.5%, or any suitable combination, sub-combination, range, or sub-range therein. In alternative embodiments, the polyolefin terephthalate copolymer is not irradiated and/or has little or no cross-linking In addition, other additives, such as stabilizers, antioxidants, colorants, lubricants, fillers or other additives, may be added to provide desired properties.

Referring to FIGS. 2 and 4, in one embodiment, a system 201, a portion of which is shown, includes the heat-recovered heat shrinkable tube 203 formed from the heat shrinkable tube 101 (see FIGS. 1 and 3). The heat shrinkable tube 101 is heat recovered in a forced air oven at a temperature (for example, 100° C. for uniform shrinkage or between 80° C. and 150° C.) for a duration (for example, 3 minutes to 5 minutes, up to 15 minutes, or longer) to heat above the glass transition temperature of the polyolefin terephthalate copolymer. Suitable glass transition temperatures include, but are not limited to, between 75° C. and 85° C., 110° C. and 120° C., or in embodiments with a blend of two or more of the polyolefin terephthalate copolymers, between 85° C. and 120° C., between 85° C. and 110° C., between 90° C. and 100° C., between 95° C. and 105° C., or any suitable combination, sub-combination, range, or sub-range therein.

The system 201 is any suitable system. Suitable systems include, but are not limited to, electrical motors, one or more of the caps 301 shown in FIG. 4 (for example, heat welded caps and/or ultrasonically welded caps), light covers, battery covers, batteries, fixture covers, fixtures, solenoids, terminating wiring, electrical pumps, splices, wraps, terminations or crimps, any suitable electrical system, or a combination thereof.

EXAMPLES

In a first example, the blend extruded to form the heat shrinkable tube 101 includes the polyolefin terephthalate copolymer being PETG (such as, Eastar Copolyester EB062 from Eastman Chemical Company, Kingsport, Tenn.) at a concentration, by weight, of 100%. The inherent viscosity is 0.75 dL/g. The heat of fusion as measured on a differential scanning calorimeter at 10° C./minute is 1 J/g and the melting temperature peak is 190° C. and 249° C. The PETG is not irradiated. The heat shrinkable tube 101 is clear and has a diameter of 0.312 inches, a tensile strength of 6650 psi, an ultimate elongation of 230%, a secant modulus of 210,000 psi, and a volume resistivity of 1.6 E+16 ohm-cm. The process of heat-recovering the heat shrinkable tube 101 to form the heat-recovered heat shrinkable tube 203 includes no irradiation (0 Mrads beam dose), a diameter expansion and/or recovery ratio of 2.4, an expansion interior diameter of 0.3125 inches, a retracted interior diameter of 0.125 inches (based upon 10 minutes at 100° C.), and a longitudinal shrinkage of 11% (based upon 10 minutes at 100° C.). The high expansion and/or recovery ratio allows a wide range of sizes to be covered by a single sized tube.

In a second example, a comparative example, heat shrinkable spiral wound tubes are opaque and have diameters between 0.156 inches and 0.5 inches. A blend for forming the heat shrinkable spiral wound tubes includes PET. The heat of fusion is 37.4 J/g and the melting temperature peak is 253° C. The diameter expansion and/or recovery ratio is between 1.3 and 1.5, with the longitudinal shrinkage being between 25% and 50%. The smaller expansion and/or recovery ratio prohibits a wide range of sizes to be covered by a single sized tube.

In a third example, a comparative example, a heat shrinkable tube is translucent and has a diameter of 0.84 inches. A blend for forming the heat shrinkable tube includes PET. The heat of fusion is 43.6 J/g and the melting temperature peak is 256° C. The diameter expansion and/or recovery ratio is 1.7 and the longitudinal shrinkage is 38%.

In a fourth example, a comparative example, a blend for forming a heat shrinkable tube includes PETG (such as Eastar Copolyester EN067 available from Eastman Chemical Company, Kingsport, Tennessee) at a concentration, by weight, of 100%. The inherent viscosity is 0.61 dL/g. The heat of fusion is 31 J/g. The melting temperature peak is 240° C. Expansion of the heat shrinkable tube based upon a diameter expansion and/or recovery ratio of 2 is not stable.

In a fifth example, the blend extruded to form the heat shrinkable tube 101 includes PETG (such as, Eastar Copolyester EB062 from Eastman Chemical Company, Kingsport, Tenn.) and terpolymer of ethylene-acrylic ester-glycidyl methacrylate (such as Lotader AX 8900 from Arkema, Colombes Cedex, France) at a concentration, by weight, of 90% PETG and 10% AX 8900. The blend is not irradiated and the modulus at 150° C. is 0 psi. The heat shrinkable tube 101 is white and has an expanded diameter of 0.310 inches. The process of heat-recovering the heat shrinkable tube 101 to form the heat-recovered heat shrinkable tube 203 includes no irradiation (0 Mrads beam dose), a diameter expansion and/or recovery ratio of 2.2, an expansion interior diameter of 0.310 inches, a retracted interior diameter of 0.140 inches (based upon 10 minutes at 100° C.), and a longitudinal shrinkage of 5% (based upon 10 minutes at 100° C.).

In a sixth example, the blend extruded to form the heat shrinkable tube 101 includes PETG (such as, Eastar Copolyester EB062 from Eastman Chemical Company, Kingsport, Tenn.) and a terpolymer of ethylene-acrylic ester-glycidyl methacrylate (such as Lotader AX 8900 from Arkema, Colombes Cedex, France) at a concentration, by weight, of 90% PETG and 10% AX 8900. The blend is irradiated with 10 Mrads increasing the modulus at 150° C. to 25 psi. The heat shrinkable tube 101 is white and has an expanded diameter of 0.310 inches. The process of heat-recovering the heat shrinkable tube 101 to form the heat-recovered heat shrinkable tube 203 includes a diameter expansion and/or recovery ratio of 2.3, an expansion interior diameter of 0.310 inches, a retracted interior diameter of 0.136 inches (based upon 10 minutes at 100° C.), and a longitudinal shrinkage of 3% (based upon 10 minutes at 100° C.).

In a seventh example, the heat shrinkable tube 101 is a sheet with a thickness of 0.01 inch and the blend compression molded into a sheet includes PETG (such as, Eastar Copolyester EB062 from Eastman Chemical Company, Kingsport, Tenn.) and triallyl isocyanurate (TAIC) at a concentration, by weight, of 97.0% PETG and 3% TAIC. The blend is irradiated at 20 Mrads, increasing the modulus at 150° C. to 15 psi.

In an eighth example, the blend includes a copolyester having a glass transition temperature of between 110° C. and 120° C. (such as, Tritan Copolyester TX1800 from Eastman Chemical Company, Kingsport, Tenn.) at a concentration, by weight, of 100%, for example, TPA with TMCD and EG. The inherent viscosity is 0.67 dL/g. The heat of fusion as measured on a differential scanning calorimeter at 10° C./minute is 0.2 J/g and the melting temperature is 200° C. The heat shrinkable tube 101 formed from the blend is clear and has a diameter of 0.315 inches, a tensile strength of 7600 psi, and an ultimate elongation of 139%. The process of heat-recovering the heat shrinkable tube 101 to form the heat-recovered heat shrinkable tube 203 includes no irradiation (0 Mrads beam dose), a diameter expansion ratio of 2.5, an expansion interior diameter of 0.315 inches, a retracted interior diameter of 0.126 inches (based upon 5 minutes at 120° C.), and a longitudinal shrinkage of 15% (based upon 5 minutes at 120° C.). The high expansion ratio allows a wide range of sizes to be covered by a single sized tube.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A heat shrinkable tube, comprising:
an extrusion of a blend, the blend comprising a first polyolefin terephthalate copolymer and a second polyolefin terephthalate copolymer, the second component having a different composition from the first polyolefin terephthalate copolymer;
wherein the extrusion is arranged as the heat shrinkable tube.

2. The heat shrinkable tube of claim 1, wherein the blend has properties selected from the group consisting of a higher viscosity than the first polyolefin terephthalate copolymer, a higher crystallinity than the first polyolefin terephthalate copolymer, a higher glass transition temperature than the first polyolefin terephthalate copolymer, and combinations thereof

3. The heat shrinkable tube of claim 1, wherein the blend further comprises at least one of a terpolymer of ethylene-acrylic ester-glycidyl methacrylate and triallyl isocyanurate for higher viscosity by irradiation.

4. The heat shrinkable tube of claim 3, wherein the blend is irradiated by at least 2 Mrads.

5. The heat shrinkable tube of claim 1, wherein the blend further comprises a polymer containing epoxide or anhydride functional groups for higher viscosity.

6. The heat shrinkable tube of claim 1, wherein the blend has a glass transition temperature of between 75° C. and 85° C.

7. The heat shrinkable tube of claim 1, wherein the blend has a glass transition temperature of between 110° C. and 120° C.

8. The heat shrinkable tube of claim 1, wherein the blend has a glass transition temperature of between 85° C. and 110° C.

9. The heat shrinkable tube of claim 1, wherein the second polyolefin terephthalate copolymer has a glass transition temperature of between 110° C. and 120° C.

10. The heat shrinkable tube of claim 1, wherein the first polyolefin terephthalate copolymer has a glass transition temperature of between 75° C. and 85° C.

11. The heat shrinkable tube of claim 1, wherein the first polyolefin terephthalate copolymer includes poly(cyclohexylene dimethylene terephthalate) glycol.

12. The heat shrinkable tube of claim 1, wherein the first polyolefin terephthalate copolymer includes poly(cyclohexylene dimethylene terephthalate) acid.

13. The heat shrinkable tube of claim 1, wherein the first polyolefin terephthalate copolymer includes poly(ethylene terephthalate) glycol.

14. The heat shrinkable tube of claim 1, wherein the heat shrinkable tube forms a heat welded cap or an ultrasonically welded cap.

15. The heat shrinkable tube of claim 1, wherein the heat shrinkable tube is positioned in an electrical motor and heat-recovered.

16. The heat shrinkable tube of claim 1, wherein the first polyolefin terephthalate copolymer and the second polyolefin terephthalate copolymer are blended at a concentration, by weight, of at least 85% in the blend.

17. The heat shrinkable tube of claim 1, wherein the first polyolefin terephthalate copolymer and the second polyolefin terephthalate copolymer are blended at a concentration, by weight, of 100% in the blend, with incidental impurities.

18. The heat shrinkable tube of claim 1, wherein the second polyolefin terephthalate copolymer includes terephthalic acid with tetramethyl-cyclobutanediol.

19. A heat shrinkable tube, comprising:
an extrusion of a blend, the blend comprising a polyolefin terephthalate copolymer;
wherein the extrusion is arranged as the heat shrinkable tube; and
wherein the blend has a glass transition temperature of at least 85° C.

20. A heat shrinkable tube, comprising:
an extrusion of a blend, the blend comprising polyolefin terephthalate copolymer;
wherein the extrusion is irradiated and expanded to form the heat shrinkable tube.
